(19) United States
(12) Patent Application Publication
(10) Pub. No.: US 2008/0279266 A1
(43) Pub. Date: Nov. 13, 2008

(54) Determining Transmission Latency

(76) Inventors: Brett Wang, Shanghai (CN); Aken Yang, Shanghai (CN); Young Guo, Shanghai (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 10/581,156

(22) PCT Filed: Dec. 28, 2005
(86) PCT No.: PCT/CN05/02332

§ 371 Date: May 31, 2006

(51) Int. Cl. H04B 17/00

(52) U.S. Cl. 375/224

(57) ABSTRACT

According to one embodiment of the invention, a method for receiving in a signal processing subsystem a first signal comprising a predetermined pattern and a second signal comprising the predetermined pattern, and determining by the signal processing subsystem a transmission latency between the received first signal and the received second signal based on the predetermined pattern. According to another embodiment a system comprising a pattern insertion subsystem to insert a predetermined pattern into a first signal and a second signal, and a signal processing subsystem to (i) receive the inserted first signal and the inserted second signal, and (ii) determine a transmission latency between the received signals based on the predetermined pattern.

### FIELD

Embodiments of the invention relate to transmission latency in networks, and more particularly to a system and method for determining transmission latency in networks.

### BACKGROUND

Computer networking is prevalent amongst many users of computing devices, such as personal computers and workstations. Networking allows users of computing devices to communicate with each other in various forms, such as the execution of a computer program (e.g., a video game), on a computing device such as a personal computer, while displaying the results on a separate system with a larger display device, such as on a home entertainment system.

Though an effective form of communication between devices, networking is not without shortcomings. One such shortcoming is in the area of latency due to the transmission of data and instructions from one device to another. In certain time-sensitive transmissions, such as real-time streaming audio transmissions, the latency could result in the audio data becoming asynchronous (out of sync) with data displayed on a display device, resulting in an undesirable presentation of an executed computer program. As such, efforts have been undertaken to better measure and reduce the transmission latencies in networks.

Currently, understanding and measuring of the transmission latency often requires a break down of the underlying data streaming system to several subsystems, then analyzing the latency of each subsystem, and thereafter determining (but not really testing) the latency of the entire data streaming system. This approach generally proves very costly to implement. For instance, it may not be possible to analyze the latency experienced by a data streaming system through analysis of the latency experienced by its subsystems. The reason is that there may exist difficulties in analyzing the latency experienced by interactions between the subsystems, such as feedback loops between the subsystems. Thus in these cases, a breakdown, or white-box analysis, may not be accurate for evaluating the latency.

In addition, network latency is often regarded as the time period between the transmittal of the first byte of a package, such as an audio package, by host computing device, and the time that a target device receives the last byte of the transmitted package. This benchmark measurement may be inaccurate, as other factors may need to be included for a more accurate latency measurement.

### BRIEF DESCRIPTION OF THE DRAWINGS

Embodiments of the invention may best be understood by referring to the following description and accompanying drawings that are used to illustrate embodiments of the invention.

FIG. 1 is a block diagram of a system in which embodiments of the invention may be practiced.

FIG. 2 is a flow chart illustrating an exemplary process according to an exemplary embodiment of the invention.

FIG. 3, FIGS. 5A-B and FIGS. 7A-B illustrate exemplary waveforms for use with an exemplary embodiment of the invention.

FIG. 4 and FIGS. 6A-B are flow charts further illustrating exemplary processes according to an exemplary embodiment of the invention.

### DETAILED DESCRIPTION

Embodiments of the invention generally relate to systems and methods for determining transmission latencies in a network environment. Herein, one embodiment of the invention may be applicable to media devices used in a variety of computing devices, which are generally considered stationary or portable electronic devices. Examples of a computing device may include, but are not limited or restricted to a computer, a set-top box, video game systems, music playback systems, and the like.

Reference in the specification to the term “one embodiment of the invention” or “an embodiment of the invention” means that a particular feature, structure, or characteristic described in connection with the embodiment of the invention is included in at least one embodiment of the invention. The appearances of the phrase “in one embodiment of the invention” in various places in the specification are not necessarily all referring to the same embodiment of the invention. Some embodiments of the invention are implemented in a machine-accessible medium. A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.), etc.

In the following description, numerous details are set forth. It will be apparent, however, to one skilled in the art, that the embodiments of the invention may be practiced without these specific details. In other instances, well-known structures and devices are shown in block diagram form, rather than in detail, in order to avoid obscuring the embodiments of the invention.

Also in the following description are certain terminologies used to describe features of the various embodiments of the invention. For example, the term “digital media adaptor” refers to a peripheral that creates a link between personal computers, TVs, and stereos. It can receive digital media from the personal computers using wireless networking technologies, and can connect to TVs and stereos using standard A/V cables. The term “software” generally denotes executable code such as an operating system, an application, an applet, a routine or even one or more instructions. The software may be stored in any type of memory, namely suitable storage medium such as a programmable electronic circuit, a semiconductor memory device, a volatile memory (e.g., random access memory, etc.), a non-volatile memory (e.g., read-only memory, flash memory, etc.), a floppy diskette, an optical disk (e.g., compact disk or digital versatile disc “DVD”), a hard drive disk, or tape. The term “signal processing system” refers to electronic circuits that remove information from signals, such as analog signals, as quantifiable units for further analysis, such as performance of mathematical operations.

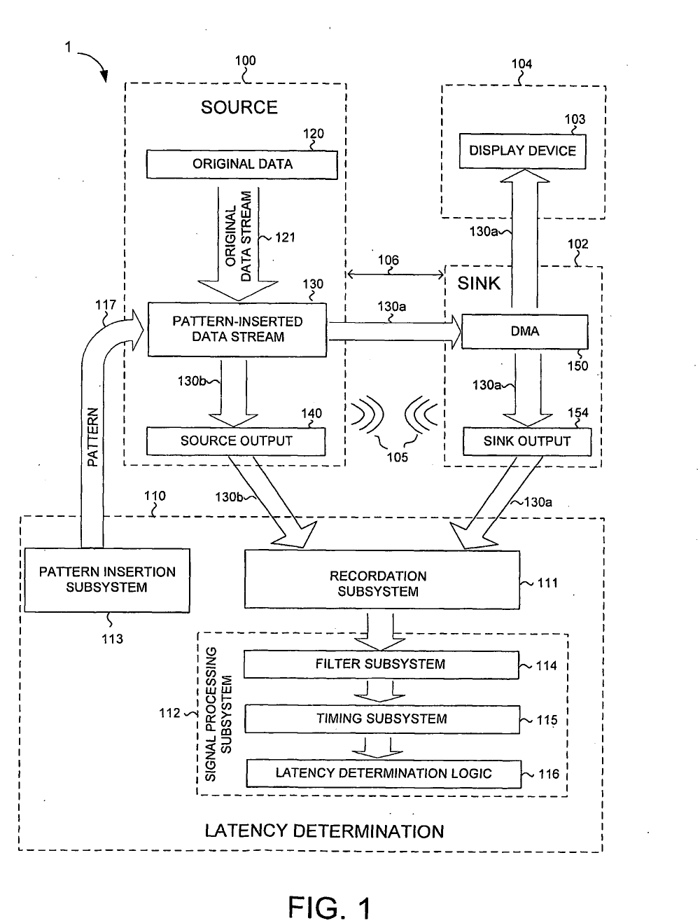

With reference to FIG. 1, an exemplary embodiment of a system, such as an audio/video system 1, is illustrated. In an exemplary embodiment of the invention, the audio/video system 1 is a remote gaming system, and comprises a source device 100, a sink device 102 and a display device 103. More specifically, according to one embodiment of the invention, the “sink device” is a device for executing a program, such as a personal computer that is able to execute a game program. The sink device 102 may be a media adaptor while the display device 103 may be a television screen for an entertainment system 104.

The source device 100 executes a game program, with the execution results, such as images and sound, transmitted to the sink device 102 such as by wireless transmission 105 and then displayed on the display device 103 of the entertainment system 104. In this way, the often larger display device 103 (compared to a smaller computer screen (not shown) of the source device 100) can be used for presenting of the images and sound to users. These transmissions from the source device 100, such as an audio source, to the sink device 102, such as an audio sink, however, are prone to end-to-end (source-to-sink) transmission latency as symbolically shown by line 106. Embodiments of the invention use a latency determination system 110 to determine the transmission latency 106 in the audio/video system 1.

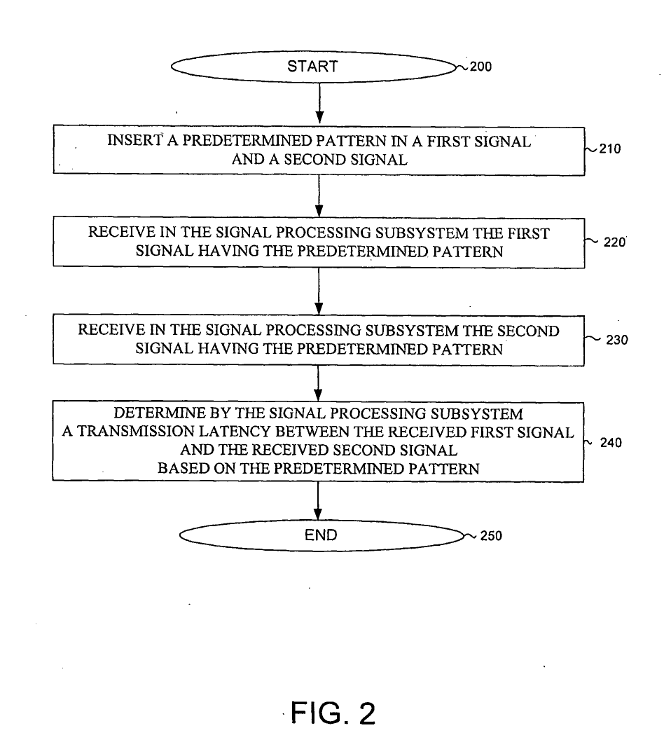

The latency determination system 110 comprises a recordation subsystem 111, a pattern insertion subsystem 113 and a signal processing subsystem 112 which includes a filter subsystem 114, a timing subsystem 115 and latency determination logic 116, as described in greater detail in conjunction with FIGS. 2-6B. The latency determination system 110 may also be implemented within the entertainment system 104, the sink device 102, source device 100 or in a separate computing device (as shown in FIG. 1) in communication with the sink device 102 and the source device 100, such as in another personal computer.

FIG. 2 is a flow chart which, in conjunction with FIG. 1, illustrates an exemplary process of an exemplary embodiment of the invention. As shown in FIG. 2 (following the start block 200), a predetermined pattern 117 is inserted in signals 130a and 130b (block 210) to form a pattern-inserted data stream 130. Signals 130a and 130b thus each comprise the original data stream 121 and the predetermined pattern 117. The pattern-inserted data stream 130 is then forwarded to source output 140 and to the sink device 102 in forms of signals 130a and 130b, each containing the same original data stream 121 and the same predetermined pattern 117. Alternatively, the predetermined pattern 117 can also be inserted separately into copies of the original data stream 121 to separately form signals 130a and 130b, which are then forwarded to the sink device 102 and to the source output 140, respectively. In an exemplary embodiment of the invention, the signal 130a is received in a digital media adaptor (DMA) 150 of the sink device 102 and then sent to the sink output 154, as well as to the display device 103.

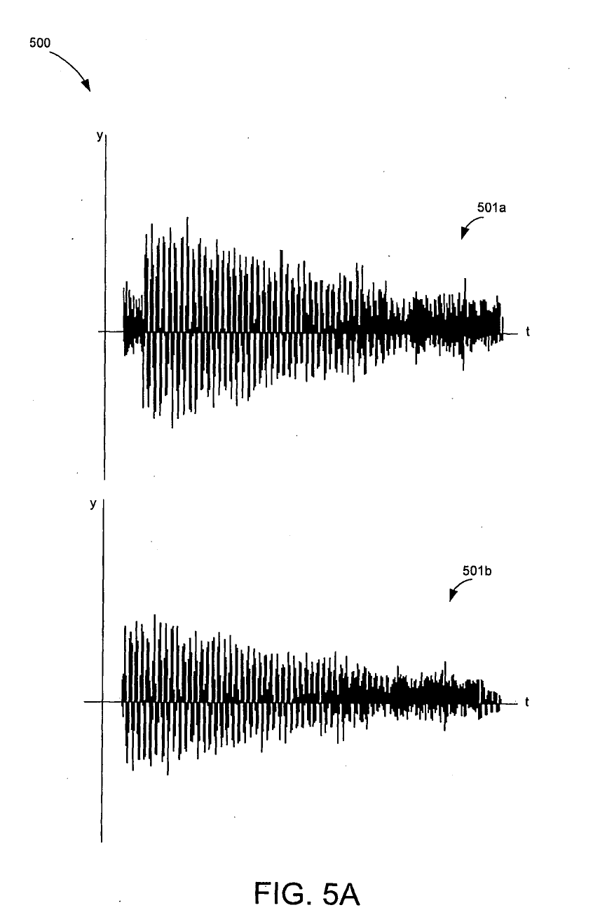

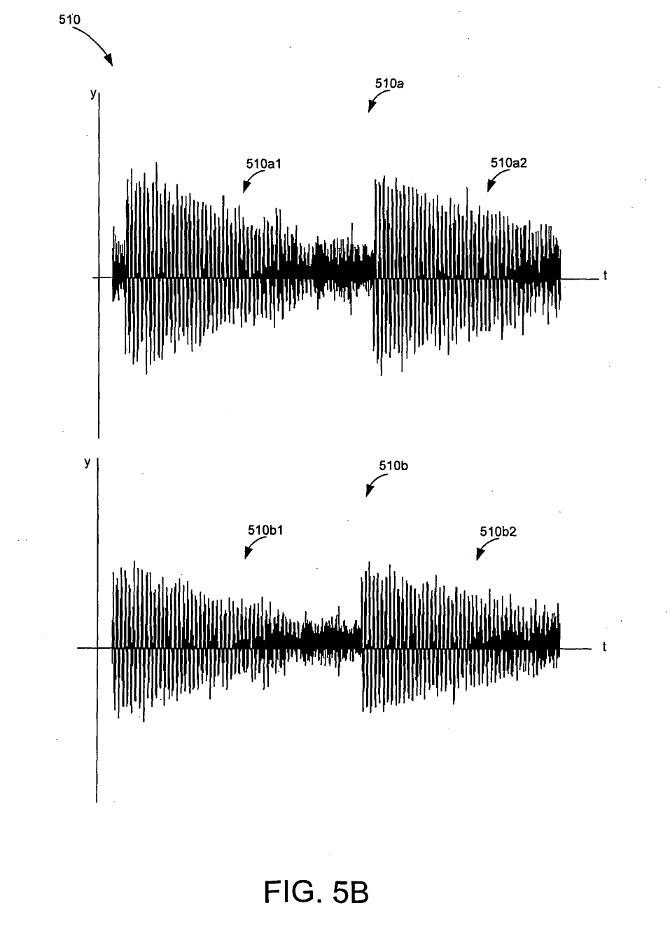

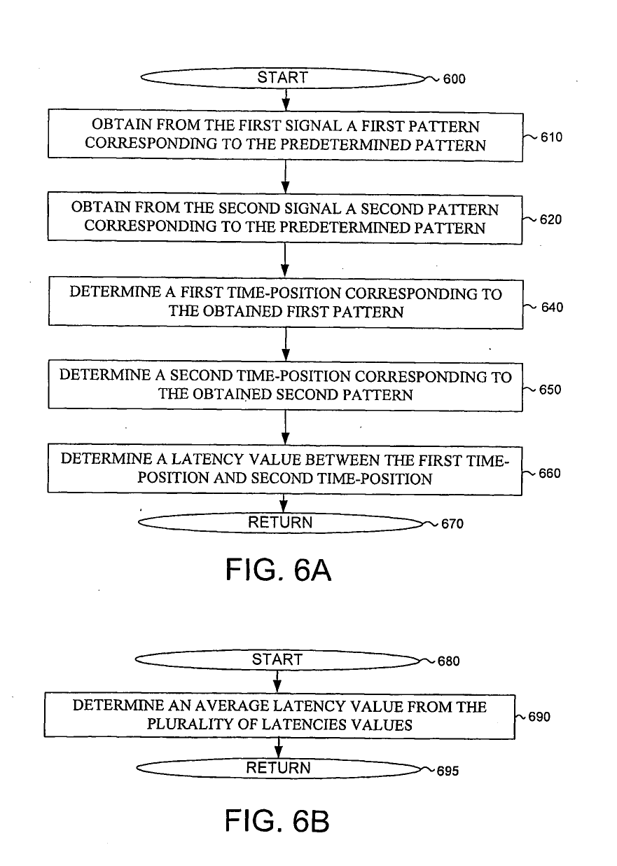

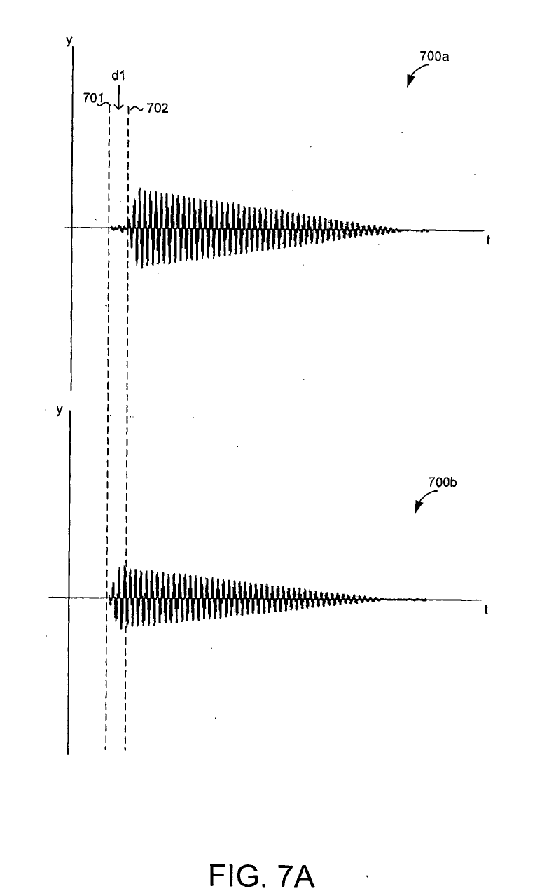

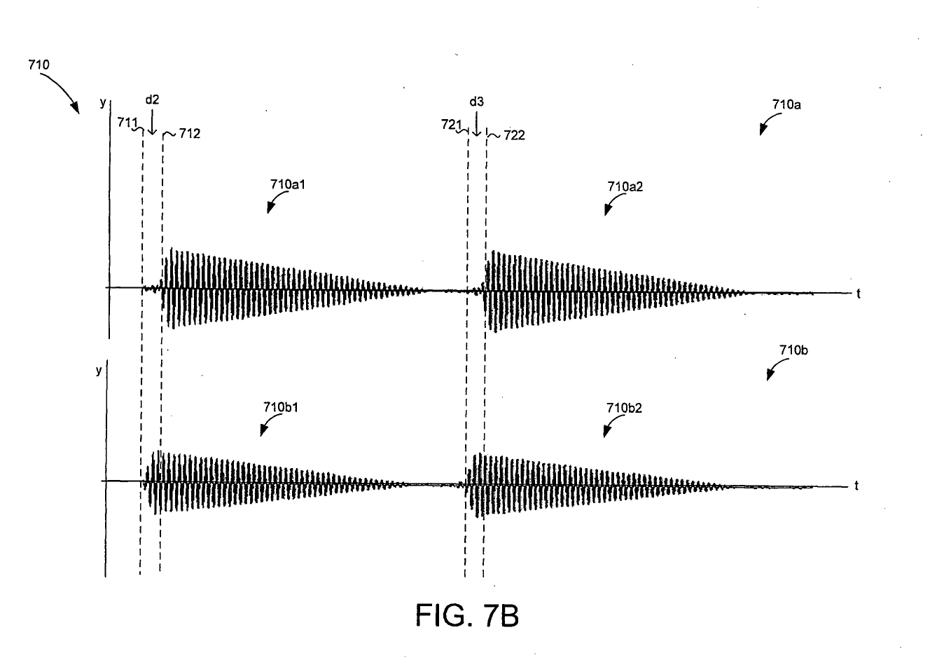

Next, signals 130a and 130b are received in the latency determination system 110 from the sink output 154 and the source output 140, respectively (blocks 220, 230). In an exemplary embodiment of the invention, the signals 130a and 130b are first received in a recordation subsystem 111 prior to their receipt in the signal processing subsystem 112, as described in greater detail in conjunction with FIG. 4 below. The signal processing subsystem 112 then determines a transmission latency 106 between the received signals 130a and 130b based on the predetermined pattern 117 (block 240), as described in greater detail in conjunction with FIGS. 6A-B below. The overall process then ends (block 250).

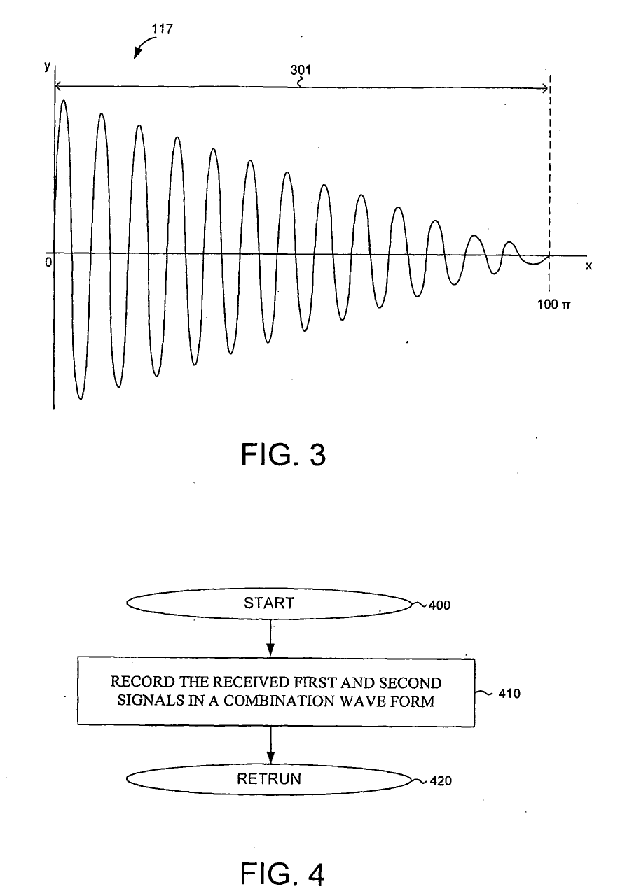

FIG. 3 illustrates an exemplary predetermined pattern 117 for use with the process of FIG. 2 (block 210). In an exemplary embodiment of the invention, the predetermined pattern 117 is a substantially sinusoidal waveform as represented in FIG. 3 using the x and y axes of the Cartesian coordinate system. The predetermined pattern 117 comprises a predetermined period 301 that is greater than a transmission latency period 106. In the example shown in FIG. 3, the waveform of the predetermined pattern 117 follows the exemplary Equation 1:

y=((100−x/π)/100)*cos(x) (Equation 1)

where “x” may range from 0.0 to 100*π (π=3.1415926 . . . ) and may be incremented at a predetermined interval such as 0.01 for example. As shown if FIG. 3, according to one embodiment of the invention, the predetermined pattern 117 generated by following Equation 1 has a finite period 301 of 100*π. Suitably, period 301 is greater than transmission latency period 106.

For example, if a transmission latency period 106 acceptable to the audio/video system 1 is less than 500 milliseconds (ms), then the waveform of the predetermined pattern 117 is predetermined to have a period 301 of for example 700 ms or larger. As shown in FIG. 1, the latency determination system 110 comprises a pattern insertion subsystem 113 which can generate and insert the predetermined pattern 117 into signals 130a and 130b. Suitably, the latency determination system 110 is programmable to generate different predetermined patterns 117 based on differently programmed instructions, such as different wave pattern equations.

FIG. 4 is an exemplary flow chart, which in conjunction with FIG. 5A, which illustrates an exemplary process for receiving the signals 130a and 130b shown in FIG. 2 (blocks 220, 230). As shown in FIG. 4, following the start (block 400), the received signals 130a and 130b are recorded in a combination waveform 500 (block 410) as shown in FIG. 5A. The transmission latency 106 between the received signals 130a and 130b is then determined by the signal processing subsystem 112 from the combination waveform 500 as described below and in greater detail in conjunction with FIG. 6A-B. The process is then returned (block 420) to FIG. 2 (block 230). As shown in FIG. 1, the latency determination system 110 comprises a recordation subsystem 111, having inputs (not shown) to receive the signals 130a and 130b. The recordation subsystem 111 then records signals 130a and 130b into the combination waveform 500.

FIG. 5A illustrates an exemplary combination waveform 500 for use with an exemplary embodiment of the invention shown in FIG. 4. As shown in FIG. 5A, the combination waveform 500 comprises a recording 501a of the signal 130a and a recording 501b of the signal 130b. The recordings 501a and 501b are then used by the signal processing subsystem 112 of FIG. 1 to determine the transmission latency 106 between the received signals 130a and 130b as described below and in greater detail in conjunction with FIG. 6A-B. Suitably, the combination waveform 500 is stored in a wave (.wav) file.

FIG. 6A is a flow chart, which in conjunction with FIG. 7A, further illustrates an exemplary process shown in FIG. 2 (block 230) in which the signal processing subsystem 112 determines the transmission latency 106 between the signals 130a and 130b. As shown in FIG. 6A, following the start (block 600), a pattern 700a (FIG. 7A) corresponding to the predetermined pattern 117 is obtained from signal 130a (block 610). In an exemplary embodiment of the invention, the pattern 700a is obtained from the recording 501a of the signal 130a (shown in FIG. 5A). Next, a pattern 700b (FIG. 7A) corresponding to the predetermined pattern 117 is obtained from signal 130b (block 620). In an exemplary embodiment of the invention, the pattern 700b is obtained from the recording 501b of the signal 130b (shown in FIG. 5A). As shown in FIG. 7A, patterns 700a and 700b have substantially the same pattern character as that of the predetermined pattern 117 but which differ somewhat from the predetermined pattern 117 due to inclusion of other signals such as noise during the transmission, and insertion processes.

Next, in FIG. 6A, time-positions 702 and 701 (FIG. 7A) corresponding to the obtained patterns 700a and 700b, respectively, are determined (blocks 640, 650). As shown in FIG. 7A, in an exemplary embodiment of the invention, time-positions 702 and 701 correspond to the start of the period for the patterns 700a and 700b, respectively.

The time-positions 702 and 701 are then used in FIG. 6A to determine a latency value between time-positions 702 and 701 (block 660); which is the transmission latency 106. As show in FIG. 7A, the time-position 702 for the signal 130a is at a later time than the time-positions 701 for the signal 130b, the difference of which is the latency value represented by d1. This is due to the transmission latency 106 caused by transmission of the signal 130a from the source device 100 to the sink device 102. For example if the start time (e.g., time position 702) of pattern 700a is at 68 ms, and the start time (e.g., time position 701) of pattern 700b is at 22 ms, then the latency value represented by d1 is determined to be 46 ms (i.e. 68 ms-22 ms). The process is then returned (block 670) to FIG. 2 (block 230).

As shown in FIG. 1, the latency determination system 110 comprises a signal processing subsystem 112 which includes a filter subsystem 114 for performing the operations of FIG. 6A (blocks 610 and 620) for filtering out patterns 700a and 700b corresponding to the predetermined pattern 117, from the signal 130a and 130b, respectively. The signal processing subsystem 112 also includes a timing subsystem 114 for performing the operations of FIG. 6A (blocks 630 and 640) for determining timing time-position 702 and 701 corresponding to the obtained patterns 700a and 700b, respectively, from the patterns 700a and 700b, respectively. The signal processing subsystem 112 also includes latency determination logic 116 for performing the operations of FIG. 6A (block 660) for determining a latency value based on the time-positions 702 and 701. The latency determination logic 116 may be, implemented in hardware or software stored on a memory storage medium (not shown).

In an exemplary embodiment of the invention, the latency determination system 110 shown in FIG. 1 can also determine a latency average by determining a plurality of latencies for signals 130a and 130b. In an exemplary embodiment of the invention, latency determination system 110 periodically samples signals 130a and 130b and applies the above-described process of FIG. 2 to each sample, to determine a latency value for each sample. In this exemplary embodiment of the invention, the operations of the recordation subsystem 111 described in FIG. 4 is applied to each received sample of the signals 130a and 130b, with each sample recorded in a combination waveform 510 as shown in FIG. 5B. As shown in FIG. 5B, in this exemplary embodiment of the invention, the combination waveform 510 comprises a plurality of recordings 510a, such as 510a1 and 510a2, with each recording corresponding to a different sampling of the signal 130a at the time (t) the signal 130a was sampled. Likewise, a plurality of recordings 510b, such as 510b1 and 510b2, is made, with each recording corresponding to a different sampling of the signal 130b, at the time (t) the signal 130b was sampled.

The process described in FIG. 6A is then applied to the recordings of each sample, such to recordings 510a1 and 510b, then to recordings 510a2 and 510b2, etc. Applying the above-described processes of FIG. 6A (blocks 610, 620) to each sample results in set of a patterns 710a (FIG. 7B), such as 710a1 and 710a2 corresponding to the predetermined pattern 117 to be obtained from samples of signal 130a. Likewise, another set of patterns 710b, such as 710b1 and 710b2, corresponding to the predetermined pattern 117 can be obtained from samples of signal 130b. In an exemplary embodiment of the invention, the patterns 710a and 710b are obtained from the recordings 510a and 510b of the samples of signals 130a and 130b, respectively (shown in FIG. 5B). Applying the above-described processes of FIG. 6A (blocks 640-660) to each sample results in the determination of time-positions for each of the samples, such as time-positions 711, 722, and 721, 722, respectively, and the subsequent determination of a latency value for each sample, such as latency values d2 and d3, respectively.

Referring to FIG. 6B, following the start (block 680), an average latency value can then be determined from the determined latency values for each sample, such as from latency values d2 and d3 (block 690). Other useful mathematical operations such as calculation of variance, etc may also be performed if desired. The process is then returned (block 695) to FIG. 2 (block 230).

The latency determination system 110 of the invention shown in FIG. 1 can also process signals that are transmitted in the stereo format. In this embodiment of the invention, the above-described processes of FIGS. 2-7B are performed once for the left channel of the stereo transmission to determine a left-channel delay, and again for the right channel to determine a right-channel delay.

In an exemplary embodiment of the invention, the software that, if executed by the latency determination system 110, will cause the latency determination system 110 to perform the above operations described in conjunction with FIGS. 2-7B is stored in a storage medium, such as in a main memory (not shown), and storage devices (not shown).

It should be noted that the various features of the foregoing embodiments of the invention were discussed separately for clarity of description only and they can be incorporated in whole or in part into a single embodiment of the invention having all or some of these features.

What is claimed is:

1. A method comprising:
receiving in a signal processing subsystem a first signal including a predetermined pattern;
receiving in the signal processing subsystem a second signal including the predetermined pattern; and
determining by the signal processing subsystem a transmission latency between the received first signal and the received second signal based on the predetermined pattern.

2. The method of claim 1, wherein the first signal is received from a first source and the second signal is received from a second source.

3. The method of claim 1, further comprising:
inserting the predetermined pattern in the first and second signals prior to receiving the first and second signals in the signal processing subsystem.

4. The method of claim 1, wherein the determining by the signal processing subsystem further comprising:
recording the received first and second signals in a combination waveform; and
determining the transmission latency between the received first and second signals from the combination waveform.

5. The method of claim 1, wherein the predetermined pattern is substantially sinusoidal and comprises a predetermined period.

6. The method of claim 5, wherein the predetermined period is greater than a transmission latency period.

7. The method of claim 1, wherein the determining by the signal processing subsystem further comprising:
obtaining from the first signal a first pattern corresponding to the predetermined pattern;
obtaining from the second signal a second pattern corresponding to the predetermined pattern;
determining a first time-position corresponding to the obtained first pattern;
determining a second time-position corresponding to the obtained second pattern; and
determining a latency value between the first time-position and second time-position, the transmission latency comprising the determined latency value.

8. The method of claim 1, further comprising:
receiving in a signal processing subsystem a plurality of first signals each comprising a predetermined pattern;
receiving in the signal processing subsystem, a plurality of second signals each comprising the predetermined pattern; and
determining by the signal processing subsystem a transmission latency between the received plurality of first and second signals based on the predetermined pattern.

9. The method of claim 8, wherein the determining by the signal processing subsystem further comprising:
obtaining a plurality of first patterns corresponding to the predetermined pattern in each of the plurality of first signals;
obtaining a plurality of second patterns corresponding to the predetermined pattern in each of the plurality of second signals;
determining a plurality of first time-positions, wherein each first time-position in the plurality of first time-positions corresponding to an obtained first pattern;
determining a plurality of second time-positions, wherein each second time-position in the plurality of second time-positions corresponding to an obtained second pattern; and
determining a plurality of latency values between the first time-positions and the second time-positions, wherein each latency value in the plurality of latency values corresponds to a latency between a first time-position and a corresponding second time-position;
determining an average latency value from the plurality of latency values, the transmission latency comprising the determined average latency value.

10. The method of claim 8, further comprising:
inserting the predetermined pattern in a plurality of first and second signals prior to receiving the plurality of first and second signals in the signal processing subsystem.

11. The method of claim 8, wherein the determining by the signal processing subsystem further comprising:
recording the received plurality of first and second signals in a combination waveform; and
determining the transmission latency between the received first and second signals from the combination waveform.

12. A system comprising:
a pattern insertion subsystem to insert a predetermined pattern into a first signal and a second signal; and
a signal processing subsystem to (i) receive the inserted first signal and the inserted second signal, and (ii) determine a transmission latency between the received signals based on the predetermined pattern.

13. The system of claim 12, the signal processing subsystem further comprising:
a filter subsystem to obtain a first pattern corresponding to the predetermined pattern from the inserted first signal and a second pattern corresponding to the predetermined pattern from the inserted second signal;
a timer subsystem to determine a first time-position corresponding to the obtained first pattern, and a second time-position corresponding to the obtained second pattern; and
a latency determination logic to determine a latency between the first time-position and second time-position wherein the transmission latency comprises the determined latency.

14. The system of claim 12, further comprising:
a recordation subsystem to record the received inserted first and second signals in a combination waveform.

15. The system of claim 14, wherein the recordation subsystem further comprising:
a first input to receive the inserted first signal; and
a second input to receive the inserted second signal.

16. The system of claim 13, wherein
the signal processing subsystem is to receive a plurality of first signals each comprising a predetermined pattern, and a plurality of second signals each comprising the predetermined pattern,
the filter subsystem is to obtain a plurality of first patterns corresponding to the predetermined pattern in each of the plurality of first signals, and to obtain a plurality of second patterns corresponding to the predetermined pattern in each of the plurality of second signals,
the timer subsystem is to determine a plurality of first time-positions, wherein each first time-position in the plurality of first time-positions corresponding to an obtained first pattern, and to determine a plurality of second time-positions, wherein each second time-position in the plurality of second time-positions corresponding to an obtained second pattern, and
the latency determination logic is to determine a plurality of latencies between the first time-positions and the second time-positions, wherein each latency in the plurality of latencies corresponds to a latency between a first time-position and a corresponding second time-position, and to determine an average latency value from the plurality of latencies, the transmission latency comprising the determined average latency.

17. The system of claim 11, wherein the first signal is received from an audio source and the second signal is received from an audio sink.

18. A storage medium that provides software that, if executed by a signal processing subsystem, will cause the signal processing subsystem to perform the following operations:
receive a first signal comprising a predetermined pattern;
receive a second signal comprising the predetermined pattern; and
determine a transmission latency between the received first signal and the received second signal based on the predetermined pattern.

19. The storage medium of claim 18, further comprising software to insert the predetermined pattern into the first and second signals prior to the receipt of the first and second signals in the signal processing subsystem.

20. The storage medium of claim 18, wherein the software, if executed by a signal processing subsystem, will cause the signal processing subsystem to perform the following operations to determine the transmission latency between the received first signal and the received second signal:
obtain from the first signal a first pattern corresponding to the predetermined pattern;
obtain from the second signal a second pattern corresponding to the predetermined pattern;
determine a first time-position corresponding to the obtained first pattern;
determine a second time-position corresponding to the obtained second pattern and
determine a latency between the first time-position and second time-position
where in the transmission latency comprises the determined latency.
